(19) United States
(12) Patent Application Publication
(10) Pub. No.: US 2011/0054775 A1
(43) Pub. Date: Mar. 3, 2011

(54) ELECTRONIC DEVICE WITH GPS APPLICATION TRIGGERED DISPLAY

(76) Inventor: Thomas David SNYDER, Cary, NC (US)

(21) Appl. No.: 12/547,005

(22) Filed: Aug. 25, 2009

(51) Int. Cl. G01C 21/00

(52) U.S. Cl. 701/201

(57) ABSTRACT

A portable electronic device includes a GPS receiver, a display and circuitry. The circuitry is configured to determine and update a position of the electronic device from data obtained by the GPS receiver as the electronic device moves. The circuitry is also configured to provide a series of navigational alerts as the electronic device moves to a user specified destination, and effect at least one of turning on or turning off the display in response to recognizing a predetermined condition relating to position or movement of the electronic device.

### TECHNICAL FIELD

The present invention relates generally to portable electronic equipment, and more particularly, to portable devices with a GPS receiver and a display for providing navigational information to the user of the device.

### BACKGROUND

In recent years, portable radio communication devices, such as mobile phones, personal digital assistants, mobile terminals, etc., have grown in popularity and continue to grow in popularity. At least anecdotally, it can be said that everyone seems to have a mobile phone these days. As the popularity of portable radio communication devices continues to grow, mobile phones and networks are being enhanced to provide services beyond voice services.

Portable electronic devices are appealing to users because of their capability to serve as powerful communication and data service tools. With the increasingly busy lifestyles of many users of portable radio communication devices, users place a premium on making efficient use of time. It is well known that position determination of portable electronic devices is highly desirable, especially in emergency situations. Several methods have been proposed and/or implemented, including various terrestrial radio triangulation techniques (TDOA, EOTD, etc.) as well as the use of the Global Positioning System (GPS). Portable electronic devices having GPS capability can be used to display information regarding the current position of the device, as well as to provide navigational information to the user, based on input from the user, such as a desired destination. Once the navigational system has been engaged, the system remains “on”, meaning that it remains active, displaying the user's current position and map until the destination is reached.

Current portable or mobile electronic equipment typically include a rechargeable or exchangeable battery as the energy source. Moreover, such electronic equipment often includes a backlight display unit. A backlight display unit can be any type of display provided with one or more light emitting elements lighting up the display, e.g. from the side, above and/or behind the display as seen from a user. Typically, the backlight display unit includes a white diffusion panel between the display and the light emitting element(s) for redirecting and scattering the light evenly to ensure a uniform lighting of the display. The display could be any type of liquid crystal display (LCD), e.g. TFT, STN, and the lighting elements could be any suitable elements, such as fluorescent tubes or light emitting diodes (LEDs), dependent on the type and size of the display. The lighting elements in backlight display units are relatively power consuming; thus the power consumption of the backlight display unit influences the lifetime of batteries in an electronic equipment considerably and thus the frequency of replacing or recharging said batteries.

For a mobile electronic device where power management is an important consideration, the “always on” navigational system can cause a significant concern. In addition, the bright light of the backlighting system can be annoying to the driver, particularly at night. The audio feedback for providing driving directions may also at times become annoying to the driver as it may interfere with conversation or listening to music, etc. However, the driver or user of the device does not want to disable the GPS function or the display and/or audio functions, and risk missing important information.

### SUMMARY

According to an aspect of the present invention, a portable electronic device includes a GPS receiver; a display; and circuitry configured to determine and update a position of the electronic device from data obtained by the GPS receiver as the electronic device moves; provide a series of navigational alerts as the electronic device moves to a user specified destination; and effect at least one of turning on or turning off the display in response to recognizing a predetermined condition relating to position or movement of the electronic device.

Another aspect relates to the circuitry being adapted to effect a power saving mode for the display in the absence of a detected predetermined condition.

Another aspect relates to the predetermined condition being a specified estimated distance from the next navigational alert.

Another aspect relates to the predetermined condition being the location of the device within a user frequented locality.

Another aspect relates to the predetermined condition being the lack of movement of the device.

Another aspect relates to the predetermined condition being the initiation of movement of the device.

Another aspect relates to the predetermined condition being a deviation from a previous navigational alert.

Another aspect relates to the predetermined condition being a modification of the user specified destination.

Another aspect relates to the display having a brightness control.

Another aspect relates to the circuitry being further configured to effect the turning on of the display with gradually increasing brightness.

Another aspect relates to the circuitry is further configured to effect the turning off of the display with gradually decreasing brightness.

Another aspect relates to the circuitry being further configured to alter the color of the display when a navigational alert is provided.

Another aspect relates to the circuitry being further configured to cause the display to blink when a navigational alert is provided.

Another aspect relates to if the device is outputting audio for user consumption that is unrelated to a navigational alert, the circuitry being further configured to cause the display to blink when a navigational alert is provided.

Another aspect relates to the audio for user consumption that is unrelated to a navigational alert is music or audio associated with a telephone call.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

FIG. 1 is a schematic illustration of the front of an electronic device, e.g., in the form of a mobile phone.

FIG. 2 is a schematic cross section through a backlight display unit.

FIG. 3 is a schematic block system diagram of the relevant portions of the electronic device of FIG. 1 in accordance with an embodiment of the present invention.

FIG. 4 is a flow chart representing one embodiment of controlling the display of the mobile device according to the present invention.

### DETAILED DESCRIPTION

As used herein, the term “electronic equipment” includes portable positioning devices, such as GPS devices, and portable radio communication devices. The term portable radio communication device, which herein after is referred to as a mobile phone, a mobile device, a mobile radio terminal or a mobile terminal, includes all devices, including, but not limited to, mobile telephones, pagers, communicators, i.e., electronic organizers, smartphones, personal digital assistants (PDAs), or the like. A portable radio communication device may also be a GPS device. Moreover, while the present invention is being discussed with respect to portable radio communication devices, it is to be appreciated that the invention is not intended to be limited to portable radio communication devices, and can be applied to any type of electronic equipment capable of use for voice and/or data communication. As used herein, the term “GPS receiver” includes any electronic equipment capable of receiving position data signals and determining its position from the received position data signal information, i.e., GPS signal information.

The portable electronic device of the present invention may include a GPS receiver; a display; and circuitry configured to (i) determine and update a position of the electronic device from data obtained by the GPS receiver as the electronic device moves; (ii) provide a series of navigational alerts as the electronic device moves to a user specified destination; and (iii) effect at least one of turning on or turning off the display in response to recognizing a predetermined condition relating to position or movement of the electronic device.

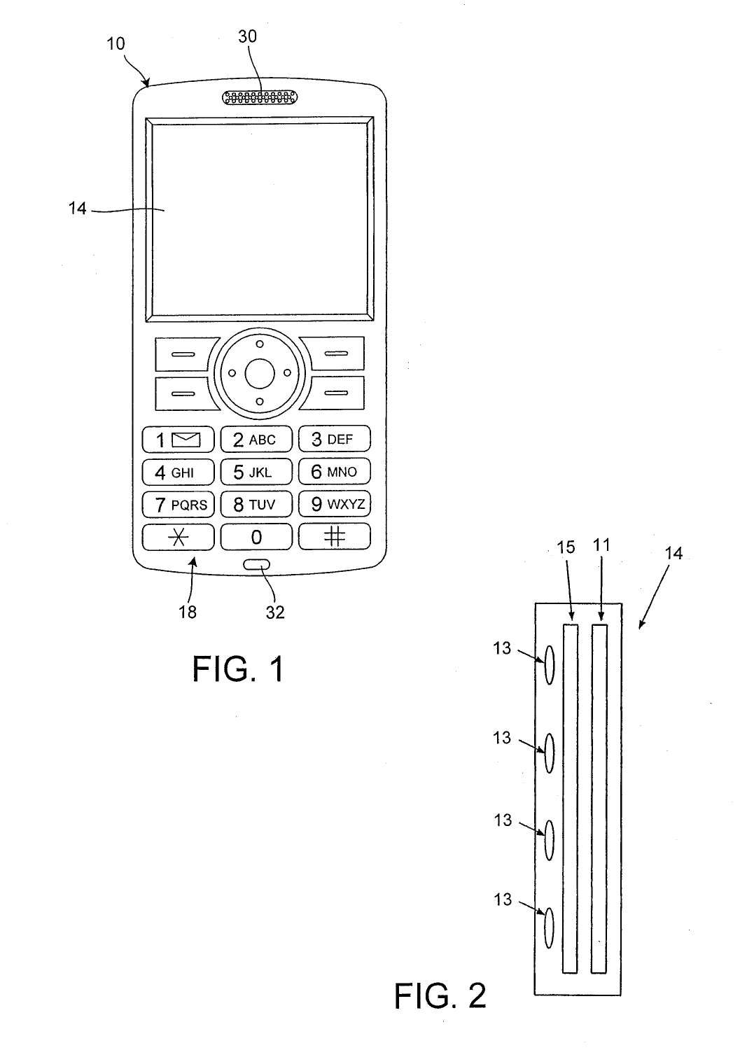

Referring in detail to the drawings, and initially to FIGS. 1 and 2, an electronic device in accordance with an embodiment of the present invention is illustrated generally as 10. The electronic device of FIG. 1 is a mobile phone that includes display unit 14, microphone 32 and a speaker 32. The electronic device further includes a keypad generally indicated at 18. The keypad 18 may include a number of keys having different respective functions. For example, the keys may include a navigation key, selection key or some other type of key, soft switched or soft keys, and dialing keys. As an example, the navigation key may be used to scroll through lists shown on the display 14, to select one or more items shown in a list on the display 14, etc. The soft switches may be manually operated to carry out respective functions, such as those shown or listed on the display 14 in proximity to the respective soft switches or selected by the navigation key, etc. The dialing keys may be used to dial a telephone number or to input alphanumeric or other data.

FIG. 2 shows a cross section through a display unit 14, corresponding to a section through the display unit 14 shown in FIG. 1. It should be noted that FIG. 1 and FIG. 2 are not to scale and that the thickness of the backlight display unit 14 in FIG. 2 is exaggerated compared to the height of the display unit 14 for the sake of clarity. Moreover, it should be noted that FIG. 2 shows the display unit 14 seen from the side, and that the part of the display unit 14 seen to the right is the part facing outwards (to be seen by a user) when the display unit is mounted in an electronic device.

The display unit 14 comprises a display element 11 with pixels (not shown) that can be activated separately to either block backlight or let it pass through to light up particular color filters. The display element 11 typically has many thousands pixels that are activated or not, making them reflect light to form images. The display element 11 could e.g. be a liquid crystal display (LCD) of any appropriate type, such as a Thin Film Transistor display (TFT display), Super Twisted Nematic display (STN display), a Color STN display (CSTN display).

The display unit 14 moreover includes a number of light emitting elements; in FIG. 2 is shown four light emitting elements 13. The light emitting elements 13 could be any suitable elements, such as fluorescent tubes, an electroluminescent (EL) panel or light emitting diodes (LEDs), dependent on the type, size and the contemplated use of the display. Moreover, the number of light emitting elements 13 could be any appropriate number, between one and tens or hundreds of light emitting elements. The light emitting elements could preferably be of a type in which the intensity of the light can be controlled. Thus, the light emitting elements 13 can be controllable to backlight specific segments (not shown in FIG. 2) of the display unit 14 at controlled intensities of light. The four light emitting elements 13 in FIG. 2 could typically correspond to four different segments of the display 14 (corresponding to four parts of the display element 11), so that the four different segments of the display can be backlit at controlled light intensity independently of the backlighting of the remaining segments by controlling the intensity of light emitted from the light emitting element 13. For example, in the case where the area of the display unit 14 is divided up horizontally into four segments and where the light emitting elements 13 consist of four horizontally oriented light tubes, the upper segment of the area of the display unit 14 can be backlit by letting the upper light tube 13 emit light, whilst the remaining light tubes are turned off so as to not emit light and thus not consume any power. In general, if only some of the segments of the display unit 14 e.g. are backlight at normal intensity and the remaining segments are backlight at reduced or no intensity, a reduction in the power consumption of the display unit 14 is obtained due to the reduction of the overall intensity of the backlighting.

Such a controlled backlighting of different segments of the display unit 14 is preferably linked to the information shown on the display unit 14 so that e.g. segments of the display unit 14 in which relevant information is displayed are backlit, while other segments without relevant information are backlit with reduced intensity or not backlit at all. The term “relevant information” is meant to cover information regarding the current use or application of an electronic equipment in which the display unit 14 is integrated or mounted.

Typically, the display unit 14 moreover contains light guiding means 15, e.g. a diffusion panel or a light guide, between the display element 11 and the light emitting elements 13 for redirecting and scattering the light evenly to ensure a uniform lighting of the display. It is conceivable that the diffusion panel or light guide 15 can be arranged to direct the light to certain segments of the display element 11 so that the light from one or more light emitting elements 13 can be directed to a controlled number of segments of the display 14. Thus, the light from two or more different light emitting elements 13 could be directed to the same segment(s) of the display unit 14 for providing backlight of a higher intensity compared with the case where each segment is backlit with light from only one light emitting element 13. Hereby, the intensity of light at the backlit element(s) is increased (in comparison with the case wherein a segment is backlit by means of only one light emitting element) or the intensity of light from each of the light emitting elements 13 backlighting said segment can be reduced without reducing the intensity of backlight to said segment (compared to the case wherein a segment is backlit by means of only one light emitting element).

In the above it is described that the reduction in power consumption of a backlight display unit can be achieved by controlling the light emitted from specific light emitting elements or by controlling a light guiding means that directs light from the light emitting elements towards the display element. It should be noted that these two approaches of course can be combined.

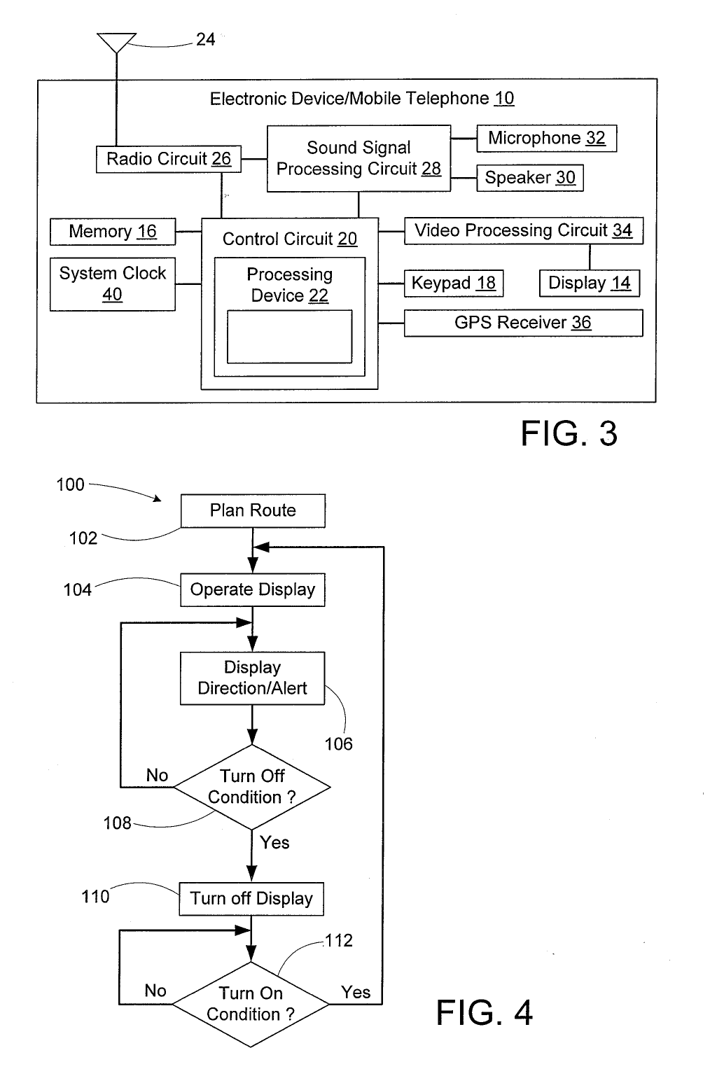

FIG. 3 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10 including the GPS receiver 36. The control circuit 20 may include a processing device 22, such as a CPU, microcontroller or microprocessor.

The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device. Details as to specific programming code have been left out for the sake of brevity.

Location information may be determined by receipt of location data from a dedicated system, such as a global positioning satellite (GPS), Galileo satellite system or the like. Such data may be received via the GPS receiver 36 as part of the electronic device 10. The location data may be processed to derive a location value, such as coordinates expressed using a standard reference system (e.g., the world geodetic system or WGS). Also, assisted-GPS (or A-GPS) may be used to determine the location of the electronic device 10. A-GPS uses an assistance server, which may be implemented with the control circuit 20. The assistance server processes location related data and accesses a reference network to speed location determination and transfer processing tasks from the electronic device 10 to the control circuit 20. For instance, the assistance server may perform tasks to make range measurements and calculate position solutions that would otherwise be carried out by the GPS receiver 36 or elsewhere in the electronic device 10.

Continuing to refer to FIG. 3, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may include a camera 42 for taking digital pictures and/or movies. Image and/or video files corresponding to the pictures and/or movies may be stored in the memory 16.

The mobile telephone 10 may include circuitry configured to (i) determine and update a position of the electronic device from data obtained by the GPS receiver as the electronic device moves; (ii) provide a series of navigational alerts as the electronic device moves to a user specified destination; and (iii) effect at least one of turning on or turning off the display in response to recognizing a predetermined condition relating to position or movement of the electronic device.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” preferably is an electronic, optical or magnetic memory for use by or in connection with the instruction execution system, apparatus, or device.

FIG. 4 is a flowchart diagram illustrating one embodiment of the mobile electronic device process for providing navigational information to the user of the device while preserving power. The process begins at block 102 where the route to be taken is planned. The GPS unit plans the route based in the input provided by the user regarding the desired destination. Once the route has been planned, the operation continues to block 104 where the display of the mobile electronic device is activated. The display may be activated by turning on the backlighting of the display. The display may include a brightness control, so that when, for example, the navigational information to be displayed is urgent, the brightness is increased. In another embodiment, the brightness of the display may be gradually increased so that the user is not visually disturbed when the display is suddenly turned on, such as when the user is driving after nightfall. The brightness of the display may also be gradually decreased as the display is turned off. The electronic device may further include a light sensor, so that the brightness of the display may be adjusted depending on the ambient light conditions.

At block 106, the direction and/or alert is displayed. The alerts are provided as the electronic device moves to a user specified destination. The display may blink when the navigational information displayed is urgent or important. The display may also blink, for example, if new directions are displayed so that the user does not have to rely on an audio alert or instruction. In one embodiment, when the electronic device detects preexisting audio signal, such as, for example, a telephone conversation or music being played, the display may turn on, blink, or alter the brightness to notify the user of a navigational alert. With this feature, the user does not have to rely on an audio alert from the GPS unit, which would interfere with the preexisting audio signal.

At block 108, an inquiry is made whether a display turn off condition has occurred. The display may be turned off in response to the device recognizing a predetermined condition relating to the position or movement of the electronic device. The preexisting turn off condition may include one or more of the following: an estimated distance to the next navigational alert being greater than a predetermined distance; an estimated time to arrive at a next navigational alert is greater than a predetermined time; the location of the device within a user frequented locality; and lack of movement of the device. In one example, if the GPS unit determines that the location of the mobile electronic device is far from the next alert or turn, a turn off condition may be indicated. In another example, if it is determined that the user is in familiar territory, such as near home or another location that the user has frequented (referred to herein as a “user frequented locality”), a turn off condition may be indicated. In yet another example, if the GPS unit determines that the user or driver has temporarily stopped the vehicle or is slowed in traffic, a turn off condition may be indicated. If any of these turn off conditions has occurred, the display may be turned off, as shown in block 110. If a turn off condition has not occurred, the display remains on and the loop is followed back to block 106 where the direction and/or alert is displayed and further inquiries are made at block 108.

At block 112, an inquiry is made whether a display turn on condition has occurred. The display may be turned on in response to the device recognizing a predetermined condition relating to the position or movement of the electronic device. The preexisting turn on condition may include one or more of the following: an estimated distance to the next navigational alert is less than a predetermined distance; an estimated time to arrive at a next navigational alert is less than a predetermined time; initiation of movement of the device; deviation from a previous navigational alert; and modification of the user specified destination. In one example, if the GPS unit determines that the mobile electronic device is nearing a course change, e.g., a turn, road change, or deviation from previous instruction, a display turn on condition may be indicated. If the GPS unit detects adverse traffic conditions approaching and/or an alternate route is suggested, a display turn on condition may be indicated. If a turn on condition is indicated, the loop is followed back to block 104 where the display is turned on. If a turn on condition is not indicated, the display remains off and the loop is followed back to block 112 where further inquiries are made.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable electronic device, comprising:
a GPS receiver;
a display;
circuitry configured to
determine and update a position of the electronic device from data obtained by the GPS receiver as the electronic device moves;
provide a series of navigational alerts as the electronic device moves to a user specified destination; and
effect at least one of turning on or turning off the display in response to recognizing a predetermined condition relating to position or movement of the electronic device.

2. The device of claim 1, the circuitry being adapted to effect a power saving mode for the display in the absence of a detected predetermined condition.

3. The device of claim 1 wherein the predetermined condition is a specified estimated distance from the next navigational alert.

4. The device of claim 1 wherein the predetermined condition is the location of the device within a user frequented locality.

5. The device of claim 1 wherein the predetermined condition is the lack of movement of the device.

6. The device of claim 1 wherein the predetermined condition is the initiation of movement of the device.

7. The device of claim 1 wherein the predetermined condition is a deviation from a previous navigational alert.

8. The device of claim 1 wherein the predetermined condition is a modification of the user specified destination.

9. The device of claim 1 wherein the display has a brightness control.

10. The device of claim 9 wherein the circuitry is further configured to effect the turning on of the display with gradually increasing brightness.

11. The device of claim 9 wherein the circuitry is further configured to effect the turning off of the display with gradually decreasing brightness.

12. The device of claim 1 wherein the circuitry is further configured to alter the color of the display when a navigational alert is provided.

13. The device of claim 1 wherein circuitry is further configured to cause the display to blink when a navigational alert is provided.

14. The device of claim 1 wherein if the device is outputting audio for user consumption that is unrelated to a navigational alert, the circuitry is further configured to cause the display to blink when a navigational alert is provided.

15. The device of claim 14 wherein the audio for user consumption that is unrelated to a navigational alert is music or audio associated with a telephone call.
